(19) United States
(12) Patent Application Publication
(10) Pub. No.: US 2002/0160117 A1
(43) Pub. Date: Oct. 31, 2002

(54) Asphalt coating material for pipes

(76) Inventors: Richard T. Janicki, Palos Park, IL (US); Katherine E. Poterek, Buffalo Grove, IL (US)

Correspondence Address: OWENS CORNING, 2790 COLUMBUS ROAD, GRANVILLE, OH, 43023, US

(21) Appl. No.: 09/845,957

(22) Filed: Apr. 30, 2001

(51) Int. Cl. B05D 3/02; B05D 1/02

(52) U.S. Cl. 427/385.5; 427/421; 524/59

(57) ABSTRACT

A coating material for coating a pipe contains asphalt and polymer dissolved in organic solvent. The coating material has Theological properties such that it can be easily applied at ambient temperature to form a coating on the pipe. After drying, the coating is resistant to abrasion as measured by at least about 1,000,000 revolutions before failure when tested by ASTM A 926-97, Procedure 7.4.

### TECHNICAL FIELD AND INDUSTRIAL APPLICABILITY OF THE INVENTION

The present invention is related generally to asphalt coating materials, and more particularly to an asphalt coating material that improves the abrasion resistance of pipes such as corrugated metal pipes for improved service life.

### BACKGROUND OF THE INVENTION

In some applications, corrugated metal pipes are exposed to flows containing abrasive bed loads or solid particulates that cause wearing of the inner wall of the pipe. For example, corrugated metal pipes used in culverts, storm sewers and sanitary sewers are exposed to the abrasive effects of stone, gravel and sand carried by water through the pipe. It is known to apply asphalt coatings to corrugated metal pipes, primarily to seal the pipes and protect them from corrosion. However, typical asphalt coatings are not very effective in protecting the pipes from abrasion.

TruFlow® polymerized asphalt coating, commercially available from Owens Coming, Toledo, Ohio, dramatically improves the abrasion resistance and durability of corrugated metal pipes. The coating is applied to the pipe by heating the coating to form a melt, and submersing the pipe in the melted coating. The need to melt the coating before application may increase manufacturing costs, and it may be impractical in field applications.

Various patents disclose asphaltic compositions for coating structures such as pipes. For example, U.S. Pat. No. 4,749,622 to Vonk et al. discloses a composition containing asphalt, elastomer, hydrocarbon resin, and inorganic filler. The composition must be melted before application by heating at a temperature between 120° C. (248° F.) and 210° C. (410° F.). A primer must be applied to the pipe before applying the asphaltic composition. There is no mention of corrugated pipes in the patent.

In view of the above, it would be desirable to provide an asphalt coating material for pipes such as corrugated metal pipes that greatly improves the abrasion resistance of the pipes, and that does not have to be melted before application.

### SUMMARY OF THE INVENTION

The above objects as well as others not specifically enumerated are achieved by a coating material for coating a pipe in accordance with the invention. The coating material comprises asphalt and polymer dissolved in organic solvent. The coating material has Theological properties such that it can be easily applied at ambient temperature to form a coating on the pipe. After drying, the coating is resistant to abrasion as measured by at least about 1,000,000 revolutions before failure when tested by ASTM A 926-97, Procedure 7.4.

The invention also relates to a method of coating a pipe to improve the abrasion resistance of the pipe. The method comprises applying a coating material which comprises asphalt and polymer dissolved in organic solvent. The coating material is applied at ambient temperature to form a coating on the pipe. After drying, the coating is resistant to abrasion as measured by at least about 1,000,000 revolutions before failure when tested by ASTM A 926-97, Procedure 7.4.

Various objects and advantages of this invention will become apparent to those skilled in the art from the following detailed description of the preferred embodiments, when read in light of the accompanying drawing.

### BRIEF DESCRIPTION OF THE DRAWING

FIG. 1 is a cross-sectional view of a corrugated pipe having an asphalt coating material applied in accordance with the present invention.

### DETAILED DESCRIPTION AND PREFERRED EMBODIMENTS OF THE INVENTION

The present invention relates to an asphalt coating material for coating pipes, to improve the abrasion resistance of the pipes. The coating material can be used on practically any type of pipe, such as metallic pipes, conduits or tubing. However, the coating material is particularly adapted to improve the abrasion resistance of corrugated pipes. Corrugated pipes include spiral, spiral rib, ridged, welded concentric rib, multi-plate corrugated pipes, and such other pipes as are generally understood in the art to be of like structure. Preferably, the pipe is metallic or partially metallic. In a preferred embodiment, the pipe is a corrugated steel pipe.

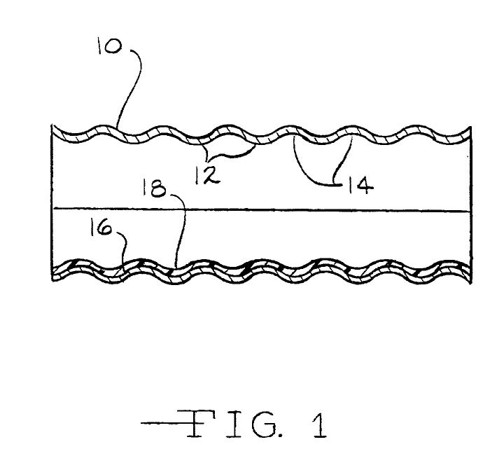

As shown in FIG. 1, a corrugated steel pipe 10 includes a plurality of alternating crests 12 and troughs 14. The corrugated pipe 10 has an inner surface or invert 16. An asphalt coating material 18 according to the invention is applied as a coating on the invert, and allowed to dry. In a typical application, the coating material is applied to cover only the bottom and part of the sides of the invert, because these are the portions of the invert that are subjected to abrasion. In other applications, the coating material is applied to cover the entire invert. The coating material may also be applied to the exterior of the pipe in some applications.

The coating material 18 effectively covers both the crests 12 and the troughs 14 of the corrugated pipe 10. Preferably, the coating material on the crests has a thickness after drying within a range of from about 40 mils (0.10 cm) to about 100 mils (0.25 cm), and the coating material on the troughs has a thickness after drying within a range of from about 100 to about 175 percent of the thickness on the crests. The coating material usually retains a corrugated appearance on the pipe.

The asphalt coating material significantly improves the abrasion resistance of pipes to dramatically increase their service life. Corrugated steel pipes coated with the coating material usually last 10 to 30 times longer than pipes coated with a standard asphalt coating. The improved abrasion resistance provided by the coating material is measured according to ASTM A 926-97, Standard Test Method for Comparing the Abrasion Resistance of Coating Materials for Corrugated Metal Pipe, Procedure 7.4 (1997). This test method covers a procedure for comparing materials used for coating corrugated metal pipe by use of a bed load abrasion testing machine. The procedure attempts to simulate the effect of stone, gravel and sand carried by a stream through corrugated metal pipe. In the procedure, curved steel panels are coated with the coating material to a thickness after drying of 50 mils (0.13 cm). The panels are mounted on the inside surface of a cylindrical drum. A charge of fine aggregate, coarse aggregate and water is added and the drum is sealed. Then the drum is rotated to cause an abrasive flow over the material being tested. The rotation of the drum is continued until failure of the coating material. As measured using a counting grid having 96 total grid squares, failure occurs when at least one of the coated panels shows more than 10 grid squares of exposed metal. The coating material of the invention can withstand at least about 1,000,000 revolutions of the drum before failure, typically at least about 1,500,000, more typically at least about 2,000,000, and preferably at least about 2,500,000.

In contrast to the TruFlow® polymerized asphalt coating, the asphalt coating material of the invention does not have to be melted before application to the pipe. The coating material can be easily applied at ambient temperature to form a coating on the pipe. As used herein, “ambient temperature” means a temperature within a range between about 40° F. (4° C.) and about 120° F. (49° C.), and typically between about 50° F. (10° C.) and about 90° F. (32° C.). The temperature referred to herein is the temperature of the coating material, which is usually but not necessarily the same as the temperature of the surrounding environment. For example, the surrounding environment may be cooler than this temperature range and the coating material may be heated to within this range, although such a coating method would be less preferred than coating without the need for any substantial heating.

The ability to apply the coating material at ambient temperature makes it practical to apply the coating material at a job site, for example, to patch bad areas of coating on a culvert pipe. The coating material can be packaged in an aerosol spray can for job site patches. In a manufacturing facility, the ability to apply the coating material at ambient temperature reduces manufacturing costs associated with melting a coating material.

The coating material can be applied to the pipe by any suitable method, such as spraying, brushing, rolling, or pouring and spreading. A spraying method is often the most economical method of application in a manufacturing facility. The coating material is readily sprayable at ambient temperature to form a coating on the pipe; it can be readily applied to the pipe using conventional spray equipment. The major types of spray equipment in use today are conventional air-atomization spray guns, airless and air-assisted airless spray guns, high-volume low-pressure spray equipment, and electrostatic spray equipment. Typically, the coating material is applied using a conventional air-atomization spray gun. The spray gun emits a stream of the coating material from a small opening in a fluid nozzle. The coating material is broken up into tiny droplets by compressed air emerging from jets adjacent to the fluid nozzle.

The coating material has Theological properties that allow it to be easily applied at ambient temperature. For example, the coating material may have a viscosity at ambient temperature within a range that allows its easy application. In a preferred embodiment, the coating material is a thixotropic gel at ambient temperature. The thixotropic gel liquefies and flows freely upon application of slight pressure or upon agitation, and it returns to the gel form when at rest. The pressure and/or agitation on the coating material during the application process cause the material to liquefy so that it can be readily applied. After the coating material has been applied on the pipe, the material returns quickly to the gel form. The gel then dries into a hardened coating.

Typically, the coating material is applied on the pipe in a thickness after drying between about 40 mils (0.10 cm) and about 100 mils (0.25 cm). The thixotropic gel form of the coating material is very resistant to flow after it has been applied on the pipe. Consequently, it can be applied in a single application to form a relatively thick coating, preferably having a thickness after drying of at least about 50 mils (0.13 cm), with substantially no sagging of the coating. In contrast, a liquid coating material such as a paint would experience sagging if applied at the same thickness.

The coating material can usually be applied as a coating on the pipe without pre-treating the pipe, such as by applying a primer, as long as the pipe is relatively clean. Also, the coating material can usually be applied in a single application instead of two or more applications. Thus, the use of the coating material provides a one-step application method that saves time and material costs.

The coating material of the invention comprises asphalt and polymer dissolved in organic solvent. The asphalt can be either a naturally occurring asphalt or a manufactured asphalt, such as an asphalt produced by refining petroleum or by other known means. Mixtures of different asphalts can also be used.

The polymer for use in the coating material can be any polymer suitable for combining with the asphalt and solvent to produce a coating material having the desired properties. Mixtures of different polymers can also be used. Preferably, the polymer is an elastomeric or rubber-like polymer that imparts resilient properties to the coating material. A coating material having greater resiliency has been found to significantly improve the abrasion resistance of the coating material on corrugated pipes. Some examples of preferred polymers include block copolymers such as styrene-butadiene-styrene (SBS), styrene-butadiene rubber (SBR), and hydrogenated styrene-butadiene-styrene (SEBS). Preferably, the block copolymer has styrene or polystyrene as an end block unit. Another preferred polymer is butyl rubber (copolymer of isobutylene and isoprene).

The organic solvent for use in the coating material can be any organic solvent capable of dissolving the asphalt and the polymer to produce a coating material having the desired properties. Blends of different organic solvents can also be used. Organic solvents are well known in the art and include, for example, various alcohols, glycols, ethers, esters, ketones, acetates, terpenes, chlorohydrocarbons, aromatic hydrocarbons and other hydrocarbons. Preferably, both the asphalt and the polymer are sufficiently soluble in the organic solvent such that coating material remains homogenous and none of the components separate from solution. Preferably, the coating material has substantially no separation after storage at 80° F. (27° C.) for 180 days. After the coating material is applied to the pipe, the organic solvent evaporates and the coating material dries and hardens. The coating material usually dries in less than about 10 hours at 72° F. (22° C.).

When the polymer is a block copolymer having styrene or polystyrene as an end block unit, the solvent is preferably highly aromatic to prevent separation of the polymer from solution. Suitable aromatic solvents include, for example, aromatic hydrocarbons such as toluene, xylene, naphthalene, benzene, and substituted benzenes.

Preferably, the coating material also includes a gelling agent. The gelling agent forms the coating material into a gel, preferably a thixotropic gel. The gelling agent may also help to prevent separation of the components from the coating material. Any gelling agent suitable for these purposes can be used. Some examples of gelling agents include clays, celluloses, organic soaps, sodium oleates, and aluminum stearates. In a preferred embodiment, the gelling agent is an inorganic layered colloidal forming clay such as an attipulgite clay, a laponite clay, or a smectite clay. When the gelling agent is a clay, preferably the coating material also includes a cationic emulsifier that reacts with the clay to form a gel structure. Preferably, the cationic emulsifier is an amine.

In a preferred embodiment, the coating material contains the following ranges of components, by weight: from about 30% to about 77% asphalt, from about 3% to about 10% polymer, from about 15% to about 45% organic solvent, from about 5% to about 20% gelling agent, and from 0% to about 10% cationic emulsifier. More preferably, the coating material comprises, by weight, about 55% asphalt, about 7% polymer, about 30% organic solvent, about 7% gelling agent, and about 1% cationic emulsifier.

The coating material can also contain minor amounts of other materials useful in asphaltic coating compositions, such as fillers, stabilizers, antioxidants and pigments.

The coating material is prepared by mixing the components together to form a homogeneous mixture. Preferably, the coating material is mixed with a high shear mixer, for a time of at least about 45 minutes. The high shear mixing helps to dissolve the polymer in the organic solvent.

A preferred embodiment of the coating material was prepared having the following composition, by weight:

61.0% TruFlow® polymerized asphalt coating, Owens Corning, containing 90% asphalt derived from petroleum distillation and 10% SBS polymer

30.8% HI SOL 10, Ashland Chemical, containing approximately 84-90% aromatic petroleum distillates, 10% naphthalene, and 0-4% trimethylbenzene

7.3% Attagel® attapulgite clay, Engelhard

0.9% Redicote® CG amine emulsifier, Akzo Chemie

The TruFlow® polymerized asphalt was heated to about 350° F. (177° C.) and mixed with a high shear Ross mixer for about 30 minutes. Heat was taken off the composition for about 15 minutes. The organic solvent, clay and amine were added and the mixing was continued for about 30 minutes. The composition was homogeneous and none of the components separated from the composition. The composition had a softening point of 193° F. (89° C.), a penetration of 70.5 dmm, a viscosity at 140° F. (60° C.) of 3775 cps, and a solids content of about 72-75%. The composition was poured and spread on panels to test for abrasion resistance by ASTM A 926-97. The composition withstood more than 2.5 million revolutions before failure.

The principle and mode of operation of this invention have been described in its preferred embodiments. However, it should be noted that this invention may be practiced otherwise than as specifically illustrated and described without departing from its scope. For example, while the coating material has been described primarily in terms of preferred compositions, it is recognized that other compositions are within the scope of the invention. Although a preferred coating material is a thixotropic gel, the coating material could also have other rheological properties as long as it can be easily applied at ambient temperature to form a coating. It should also be noted that while the coating material has these properties, the composition of the invention is not limited to any particular method of coating.

What is claimed is:

1. A coating material for coating a pipe, comprising asphalt and polymer dissolved in organic solvent, the coating material having Theological properties such that it can be easily applied at ambient temperature to form a coating on the pipe, the coating after drying being resistant to abrasion as measured by at least about 1,000,000 revolutions before failure when tested by ASTM A 926-97, Procedure 7.4.

2. A coating material according to claim 1 wherein the coating material is a thixotropic gel at ambient temperature, such that the coating material liquefies when being applied and re-forms a gel after application.

3. A coating material according to claim 1 wherein the applied coating material is resistant to flow at ambient temperature, such that the coating material can be applied in a single application to form a coating having a thickness after drying of at least about 50 mils (0.13 cm) with substantially no sagging of the coating.

4. A coating material according to claim 1 wherein the coating material has substantially no separation after storage at 80° F. (27° C.) for 180 days.

5. A coating material according to claim 1 wherein the organic solvent is aromatic.

6. A coating material according to claim 1 wherein the coating dries in less than about 10 hours at 72° F. (22° C.).

7. A coating material for coating a corrugated pipe, comprising asphalt and polymer dissolved in organic solvent, the coating material having rheological properties such that it can be easily applied at ambient temperature to form a coating on the pipe, the coating material being a thixotropic gel at ambient temperature such that the coating material liquefies when being applied and re-forms a gel after application, the coating after drying being resistant to abrasion as measured by at least about 1,000,000 revolutions before failure when tested by ASTM A 926-97, Procedure 7.4, and the applied coating material being resistant to flow at ambient temperature such that the coating material can be applied in a single application to form a coating having a thickness after drying of at least about 50 mils (0.13 cm) with substantially no sagging of the coating.

8. A coating material according to claim 7 additionally comprising a gelling agent.

9. A coating material according to claim 8 wherein the gelling agent is a clay, and additionally comprising an amine emulsifier that reacts with the clay to form a gel.

10. A coating material according to claim 7 wherein the polymer is a block copolymer containing a styrene or polystyrene end block unit.

11. A coating material according to claim 10 wherein the organic solvent is aromatic.

12. A coating material according to claim 7 wherein the coating material comprises, by weight, from about 30% to about 77% asphalt, from about 3% to about 10% polymer, from about 15% to about 45% organic solvent, from about 5% to about 20% gelling agent, and from about 0% to about 10% cationic emulsifier.

13. A coating material according to claim 12 wherein the coating material comprises, by weight, about 55% asphalt, about 7% polymer, about 30% organic solvent, about 7% gelling agent, and about 1% cationic emulsifier.

14. A method of coating a pipe to improve the abrasion resistance of the pipe, the method comprising applying a coating material which comprises asphalt and polymer dissolved in organic solvent, the coating material being applied at ambient temperature to form a coating on the pipe, the coating after drying being resistant to abrasion as measured by at least about 1,000,000 revolutions before failure when tested by ASTM A 926-97, Procedure 7.4.

15. A method according to claim 14 wherein the coating material is applied by spraying.

16. A method according to claim 14 wherein the coating material is a thixotropic gel at ambient temperature, such that the coating material liquefies when being applied and re-forms a gel after application.

17. A method according to claim 14 wherein the coating material is applied in a single application to form a coating having a thickness after drying of at least about 50 mils (0.13 cm) with substantially no sagging of the coating.

18. A method according to claim 14 wherein the coating material is applied to form a coating having a thickness after drying between about 40 mils (0.10 cm) and about 100 mils (0.25 cm).

19. A method according to claim 14 wherein the coating material is applied without pre-treating the pipe.

20. A method according to claim 14 wherein the coating material is applied to form the coating on a corrugated pipe, the coating step being effective to coat both the crests and the troughs of the corrugated pipe.
